(19) United States
(12) Patent Application Publication
(10) Pub. No.: US 2023/0413720 A1
(43) Pub. Date: Dec. 28, 2023

(54) SEED TUBE GUARD AND ASSOCIATED SYSTEMS AND METHODS OF USE

(71) Applicant: Ag Leader Technology, Ames, IA (US)

(72) Inventors: Alan F. Barry, Nevada, IO (US); Nick Schwartz, Story City, IA (US)

(21) Appl. No.: 18/215,721

(22) Filed: Jun. 28, 2023

Related U.S. Application Data
(63) Continuation-in-part of application No. 18/081,432, filed on Dec. 14, 2022.
(60) Provisional application No. 63/289,456, filed on Dec. 14, 2021.
(60) Provisional application No. 63/357,082, filed on Jun. 30, 2022.

(51) Int. Cl. A01C 7/20

(52) U.S. Cl. CPC A01C 7/201; A01C 7/206

(57) ABSTRACT

A seed delivery shield, comprising a shield body comprising at least one roll pin opening configured for mounting the shield body to a row unit shank via a roll pin and at least one debris relief opening, a retention apparatus configured to attach the shield body to a row unit, and a spring plate shaped to be at least partially engaged with a rear portion of the shield body and extending rearward toward a seed delivery tube. The spring plate configured to protect the row unit and seed tube from damage during and prior to planting operations.

### CROSS-REFERENCE TO RELATED APPLICATION(S)

This application is a continuation in part of U.S. application Ser. No. 18/081,432, filed Dec. 14, 2022, which claims the benefit under 35 U.S.C. § 119(e) to U.S. Provisional Application 63/289,456, filed Dec. 14, 2021, and entitled “Seed Tube Guard”. This application also claims the benefit under 35 U.S.C. § 119(e) to U.S. Provisional Application 63/357,082, filed Jun. 30, 2022, and entitled “Seed Tube Guard”. Each of the above applications are hereby incorporated herein by reference in their entirety for all purposes.

### TECHNICAL FIELD

The disclosure relates to row crop planters and more particularly devices for technology relating to the protecting seeding systems and devices, including seed tube guards.

### BACKGROUND

Various configurations of row crop planters and row units are known in the art. These known planters and row units all have some mechanical similarities. As shown in FIGS. 1 and 2, planters 10 consist of a plurality of substantially identical row units 12. The row units 12 typically include a pair of disc opener blades 14 that meet to enter the soil and then diverge to force the soil into the shape of a furrow. Row units 12 may also optionally include gauge wheels 16, closings discs 18, a firmer (not pictured), and/or a row cleaner (not pictured).

Also disposed on various known row units 12 is a seed delivery system 24. The seed delivery system 24 being configured to deposit seeds within the furrow formed by the opening discs 14. In various known implementations, at the rear of the opening discs 14 is a seed delivery tube 26 intended to provide a path for the seed to fall from a seed meter 28 to the furrow. The seed delivery tube 26 is usually made of plastic and is therefore fairly fragile. To keep the seed delivery tube 26 from being knocked out of position or damaged a replaceable component commonly known as a seed tube guard may be included in the assembly.

Known variations of seed tube guards 27 are shown in FIGS. 3 and 4. Various manufacturers use various known designs to protect the seed tube 26 from impact damage. Another known purpose of a seed tube guard 27 is to serve as a point of contact for the furrow opener discs 14 to support the opener discs 14 as soil forces push the discs 14 inward. This force tends to rapidly wear away the seed tube guard 27, such that in heavy use conditions the seed tube guard 27 is a part that may be frequently replaced.

Because the seed tube guard 27 is frequently replaced many manufacturers have devised ways to retain the seed tube guard 27 on the row unit 12 while requiring few or no tools to remove and replace seed tube guard 27. For example, some manufacturers hang the seed tube guard 27 from pins, while others use a twist and lock method, as would be appreciated.

Planters with high-speed seed delivery systems 24, such as paddle belts 30 that deliver seed to the seed furrow at speeds in excess of the rate of gravity (6-12 mph), such as that shown in FIG. 5, have different protection requirements when compared to traditional planting equipment. For example, a delivery belt 30 that carries seed to the furrow can also pick up field residue and pull it into the seed tube 26 causing interference or interruption in the smooth motion of the belt 30 around the pulley(s) 32. This, in turn, can lead to damage to the delivery mechanism 24 and/or cause it to operate erratically leading to reduced performance.

To protect high-speed delivery systems 24, the conventional seed tube guard 27 employed in prior known commercial designs includes an extension 29 expanded to wrap around the bottom of the seed delivery assembly 24, as shown for example in FIG. 4. The extension 29 has the effect of deflecting residue as the planter 10 moves forward and residue pieces are not as likely to be caught in the moving belt 30 where it is exposed to discharge seeds.

Because the seed tube guard 27 extension 29 is located below the seed delivery tube 26 it is very close to the soil surface as the row unit 12 is drawn across the field while planting. In certain known designs, the lower end of the seed tube guard 27 will operate within the seed furrow directly in front of seed delivery tube 26.

Additionally, if the planter row unit 12 is lowered to the ground before there is forward motion, and therefore no seed furrow is formed below the seed tube 26 and/or seed tube guard 27, the seed tube guard 27 will sit directly on the ground and support the entire weight of the row unit 12 and any additional downforce that is supplied. Then, as the row unit 12 is drawn forward, the weight of the row unit 12 plus the rearward drag is transferred to the row unit 12 attachment location for the seed tube guard 27. Damage to the structure of the row unit 12 can occur because many row units 12 are not intended to survive this type of loading.

Because the seed tube guard 27 must have sufficient structure to withstand weight set upon it, the portion of the guard 27 below the seed delivery tube 26 must be thick. This necessary thickness limits the location of the lowest point of the seed delivery tube 26, which may decrease the accuracy of seed placement. If positioned in the furrow just formed by the disk opener blades 14, the seed tube guard 27 lower structure (extension 29) can disturb the furrow shape and also wear prematurely due to soil abrasion.

Further, ground forces also create higher side loads on the disc opener discs 14 when planting at high speed. These side loads need to be resisted by the seed tube guard 27 in order to give it a usable life. To accomplish this the seed tube guard 27 may include high wear resistant surfaces 31 located at the lowest end of the seed tube guard 27 and designed to contact the inner surfaces of the opener discs 14. This added support improves the life of the opener discs 14 and the disc bearings, but also introduces rearward drag due to friction and the rotation of the opening discs 14. These forces can also add stress to the mounting locations of the seed tube guard 27.

Additionally, planter shanks, an optional mounting location for a seed tube guard 27, may break due to high-speed planting or planting in hard ground, as would be understood. This breakage can cause significant down time in the planting season, negatively effecting output and efficiency. Further, opening discs 14 can experience premature wear due to debris ingression causing a guard to become off center with respect to the seed tube 26 and opening discs 14.

There is a need in the art for improved devices for protecting seed tubes and seed delivery assemblies, particularly those in use with high-speed planting.

### BRIEF SUMMARY

Disclosed herein are various row units and components thereof for shielding seed delivery components. Additionally, disclosed herein are various implementations of a seed tube guard having a roll pin mount to alleviate stress around roll pin mounting features. Various implementations may also include one or more cutouts configured to shed buildup between the guard and row unit shank.

In Example 1, a seed delivery system shield, comprising a shield body, a side retention apparatus configured to maintain alignment of the shield body to a seed tube, and a spring plate shaped to be at least partially engaged with a rear portion of the shield body and extending rearward beneath the seed tube.

Example 2 relates to the shield of Example 1, wherein the spring plate is high carbon spring steel.

Example 3 relates to the shield of any of Examples 1-2, wherein the spring plate further comprises a first portion shaped to be fitted with a side of the shield body, a second portion forming a radius connecting the first portion and a third portion, and the third portion extending from the second portion opposite the shield body.

Example 4 relates to the shield of any of Examples 1-3, wherein the first portion of the spring plate is configured to act as a lever against forced exerted on the third portion of the spring plate.

Example 5 relates to the shield of any of Examples 1-4, wherein the third portion of the spring plate is substantially flat.

Example 6 relates to the shield of any of Examples 1-5, wherein the second portion of the spring plate is wrapped at least partially around a spring pin.

Example 7 relates to the shield of any of Examples 1-6, wherein the spring plate further comprises an elongated aperture centrally located along the second portion.

Example 8 relates to the shield of any of Examples 1-7, wherein the shield body further comprises a tang configured to retain a spring pin.

Example 9 relates to the shield of any of Examples 1-8, wherein the spring pin and the spring plate are configured to cooperate to prevent undue loading on a row unit.

Example 10 relates to the shield of any of Examples 1-9, further comprising one or more wear pads on the shield body.

Example 11 relates to the shield of any of Examples 1-10, wherein the one or more wear pads are carbide.

In Example 12, a shield for protecting a seed delivery system, comprising a shield body, a spring plate, and a spring pin configured to hold the spring plate to the shield body wherein deflection of the spring plate occurs at the second portion of the spring plate and the spring pin. The spring plate comprising a first portion shaped to be engaged with a rear portion of the shield body, a second portion extending rearwardly from the first portion to below a seed tube of the seed delivery system, and a third portion connecting the first portion and the second portion of the spring plate.

Example 13 relates to the shield of Example 12, wherein the spring plate deflects vertically.

Example 14 relates to the shield of any of Examples 12-13, wherein the spring plate prevents field residue from being picked up by the seed delivery system.

Example 15 relates to the shield of any of Examples 12-14, further comprising a side retention device extending from the shield body and configured to maintain alignment of the shield and the seed tube.

Example 16 relates to the shield of any of Examples 12-15, wherein the second portion is substantially flat.

Example 17 relates to the shield of any of Examples 12-16, wherein the shield body comprises a tang extending through an elongate aperture in the third portion to retain the spring pin.

Example 18 relates to the shield of any of Examples 12-17, wherein row unit loading is at least partially absorbed by the spring pin and the spring plate.

Example 19 relates to the shield of any of Examples 12-18, further comprising one or more wear pads on the shield body.

Example 20 relates to the shield of any of Examples 12-19, further comprising at least one debris relief opening and wherein the shield body is configured to be mounted to a row unit shank via a roll pin.

In Example 21 a seed tube shield for use on an agricultural row unit, comprising a shield body, a spring plate, a tang extending from the shield body configured to retain a spring pin and extend through an elongate aperture in the third portion, at least two wear pads, disposed on opposing sides of the shield body, and a retention device extending rearwardly from the shield body configured to maintain alignment of a seed tube. The spring plate comprising a first portion shaped to be engaged with a rear portion of the shield body, a second portion extending rearwardly from the first portion, and a third portion connecting the first portion and the second portion of the spring plate.

In Example 22, a seed delivery system shield, comprising a shield body, a side retention apparatus configured to maintain alignment of the shield body to a seed tube, a spring plate shaped to be at least partially engaged with a rear portion of the shield body and extending rearward beneath the seed tube, and an opening disposed at a proximal end of the shield body configured for insertion of a roll pin for mounting the shield body to a row unit shank.

Example 23, relates to the seed delivery system shield of Example 22, further comprising at least one debris relief opening at a proximal end of the shield body.

In Example 24, a seed tube shield for use on an agricultural row unit, comprising a shield body comprising at least one roll pin opening configured for mounting the shield body to a row unit shank via a roll pin and at least one debris relief opening, a spring plate, a tang extending from the shield body configured to retain a spring pin and extend through an elongate aperture in the third portion, at least two wear pads, disposed on opposing sides of the shield body, and a retention device extending rearwardly from the shield body configured to maintain alignment of a seed tube. The spring plate comprising a first portion shaped to be engaged with a rear portion of the shield body, a second portion extending rearwardly from the first portion, and a third portion connecting the first portion and the second portion of the spring plate.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a perspective view of a planter, according to one implementation.

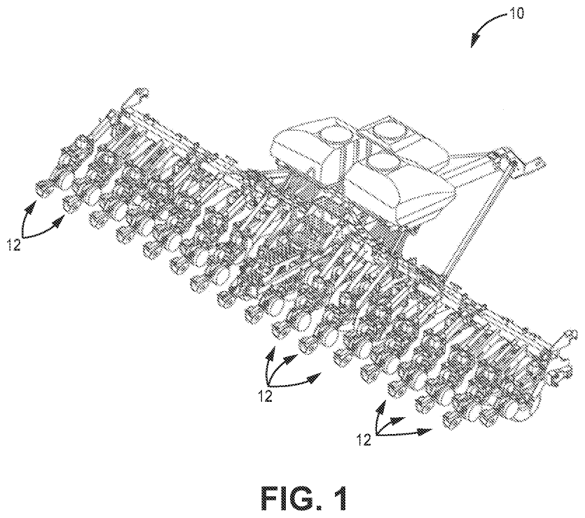

FIG. 2 is a side view of a planter row unit, according to one implementation.

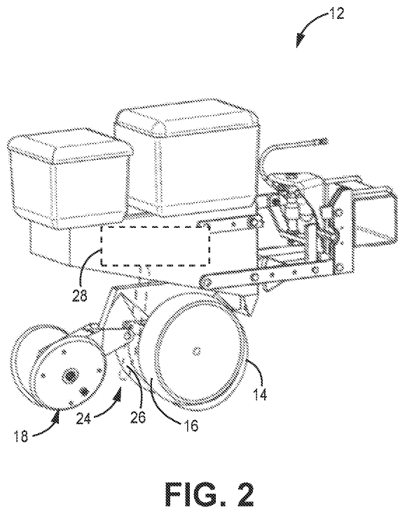

FIG. 3 is a side view of a conventional seed tube shield not intended for high-speed planting.

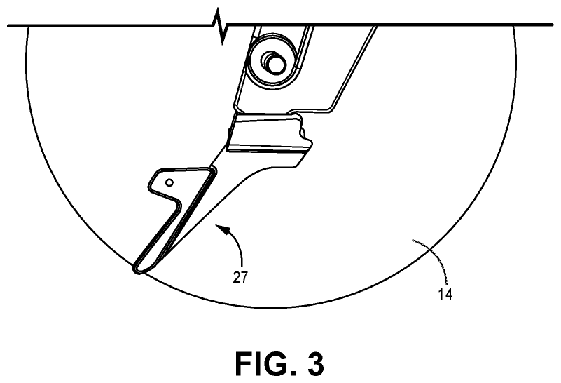

FIG. 4 is a side view of a prior known seed delivery shield with a structure that wraps below the seed delivery mechanism.

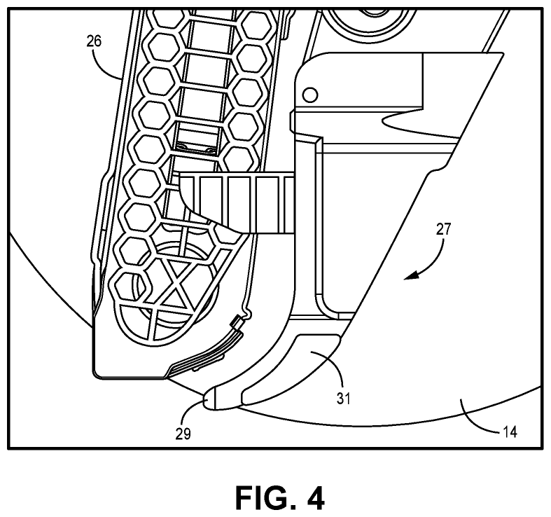

FIG. 5 is a cross-sectional view of a seed tube, according to one implementation.

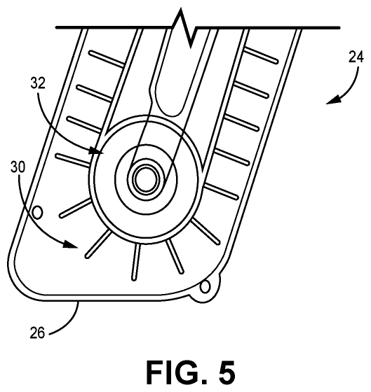

FIG. 6A is a side view of a seed tube shield installed with a seed tube, according to one implementation.

FIG. 6B is a side view of a seed tube shield, according to one implementation.

FIG. 6C is a side view of a seed tube shield, according to one implementation.

FIG. 6D is a side view of a seed tube shield, according to one implementation.

FIG. 7A shows a perspective view of the spring plate, according to one implementation.

FIG. 7B shows a rear view of the spring plate, according to one implementation.

FIG. 7C shows a perspective view of the spring plate, according to one implementation.

FIG. 8A shows a perspective view of a seed tube shield, according to one implementation.

FIG. 8B shows a perspective view of a seed tube shield, according to one implementation.

FIG. 8C shows a rear view of a seed tube shield, according to one implementation.

FIG. 8D shows a close-up, perspective view of a spring plate on a seed tube shield, according to one implementation.

FIG. 8E shows a close-up, rear view of a spring plate on a seed tube shield, according to one implementation.

FIG. 8F shows a close-up, side view of a spring plate on a seed tube shield, according to one implementation.

FIG. 8G shows a perspective view of a seed tube shield, according to one implementation.

FIG. 8H shows a perspective view of a seed tube shield, according to one implementation.

FIG. 9A is an exploded view of a seed tube shield, according to one implementation.

FIG. 9B is an exploded view of a seed tube shield, according to one implementation.

FIG. 10 is a side schematic view of a seed tube shield with seed tube, according to one implementation.

FIG. 11 is a side view of a lower portion of a row unit, according to one implementation.

FIG. 12 is a side view of a row unit shank, according to one implementation.

FIG. 13 is a side view of a seed tube guard mounted to the row unit shank, according to one implementation.

FIG. 14 is a side view of a row unit shank, according to one implementation.

FIG. 15A is a side view of a seed tube guard mounted to the row unit shank, according to one implementation.

FIG. 15B is a side view of a seed tube guard mounted to the row unit shank with a spring plate, according to one implementation.

FIG. 16 is a rear view of a seed tube guard mounted to the row unit shank, according to one implementation.

FIG. 17 is a side view of a row unit having a seed tube guard with a spring plate, according to one implementation.

### DETAILED DESCRIPTION

The devices and methods described herein relate to protecting planter row units and components thereof, particularly seed delivery components. Various shield implementations described herein are directed to addressing numerous issues identified above including undesirable loading of the row unit structure while preventing field residue from being picked up by an exposed seed delivery belt. Various additional implementations described herein are related to a mounting mechanism for the shield configured to reduce stress on the row unit shank.

### Seed Tube Guard

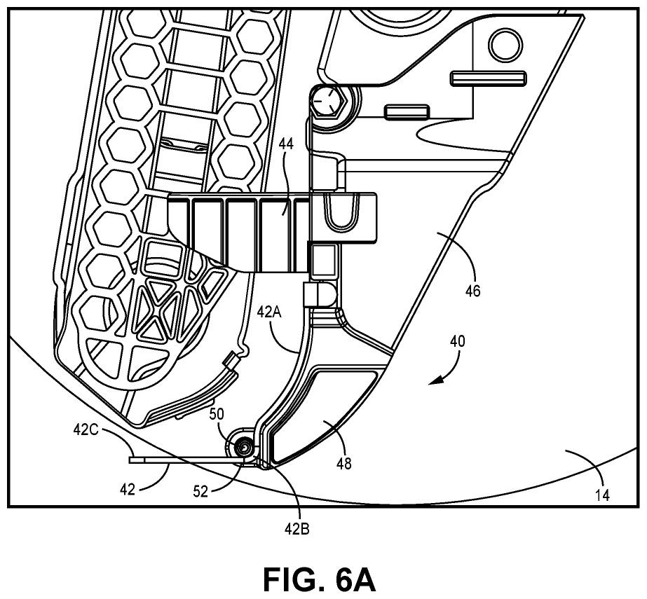

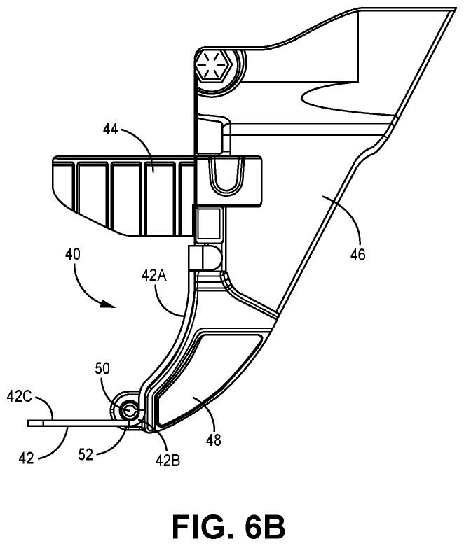

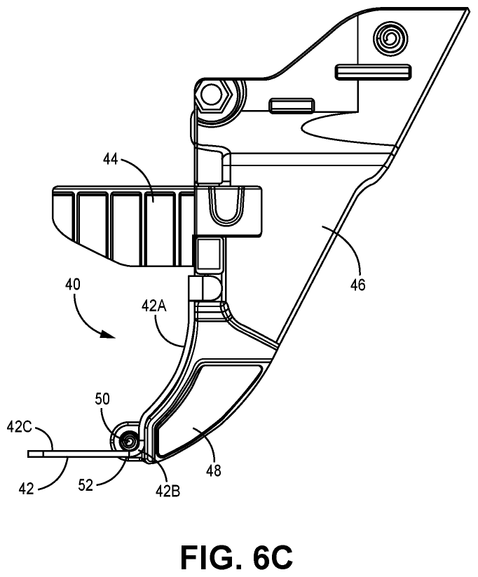

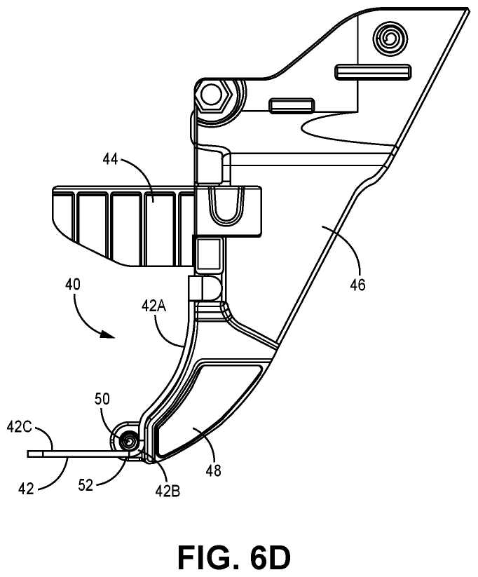

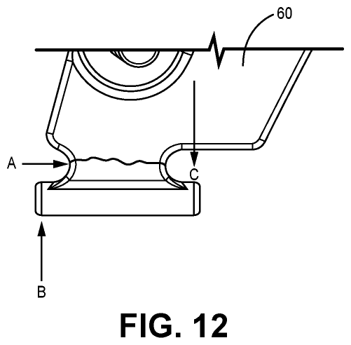

Turning now to the figures in more detail, in various implementations, the shield 40 includes a spring plate 42, a body 46, and side retention device 44, shown for example in FIGS. 6A-D. In these implementations, a spring plate 42 and spring pin 50 cooperate to prevent undue loading on the row unit structure (such as a shank 60, shown in FIGS. 12-17 and discussed further below) while preventing field residue from lifting off the soil surface until the seed is planted. In these and other implementations, the side retention device 44 is configured to maintain the alignment of the seed tube 26 and the seed delivery shield 40, as would be readily appreciated.

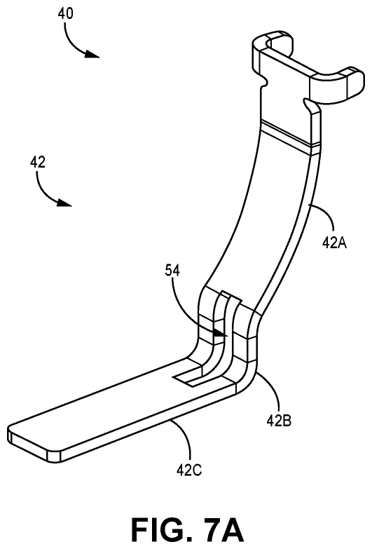

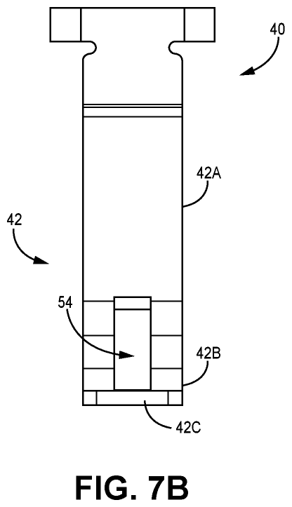

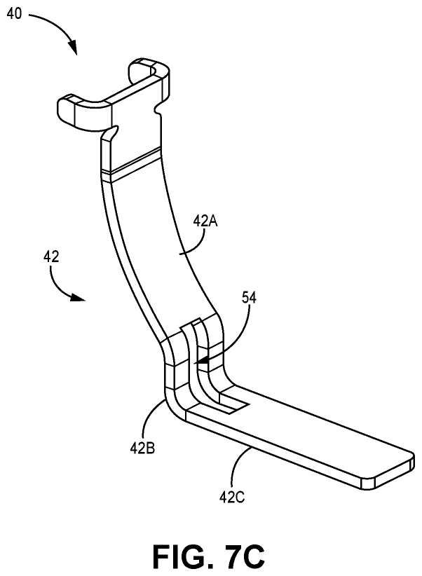

In various implementations, the spring plate 42 is a resilient wear resistant part shaped to fit with and follow the contour of the rear side of the body 46 of the seed tube shield 40 and extend rearward below a seed tube 24. In certain implementations, the spring plate 42 is made from thin high carbon spring steel or other appropriate material, as would be appreciated. In various implementations, the spring plate 42 includes an upper curved portion 42A, a formed radius 42B, and an extension 42C portion, shown variously in FIGS. 7A-7C. In these and other implementations, the upper curved portion 42A is shaped to maintain maximum physical clearance with the seed tube shield 40 and act as a lever to react against any upward forces imparted to the extension 42C of the spring plate 42, such as by field residue, rearward drag from advancing the row unit, weight of the row unit or downforce applied to the row unit when resting on unopened soil. As would be appreciated, the spring plate 42, provides protection for the lower end of the seed delivery tube. This includes protection from picking up field residue, soil, etc. The spring plate 42 also deflects debris, like rocks, that might impact the lower end of the delivery tube and is optionally sacrificial.

It would further be appreciated that the spring plate 42 can, in various implementations, be inexpensive and easily replaced. In various implementations, the spring plate 42 may be easily replaced by removing the spring pin 50, removing the spring plate 42 from the shield body 46 and then placing a new spring plate 42 on the shield body 46 and replacing the spring pin 50. In these and other implementations, the spring plate 42 can be replaced without removing the shield body 46 from the row unit. Various alternative methods and mechanisms for replacing the spring plate 42 are possible and would be appreciated.

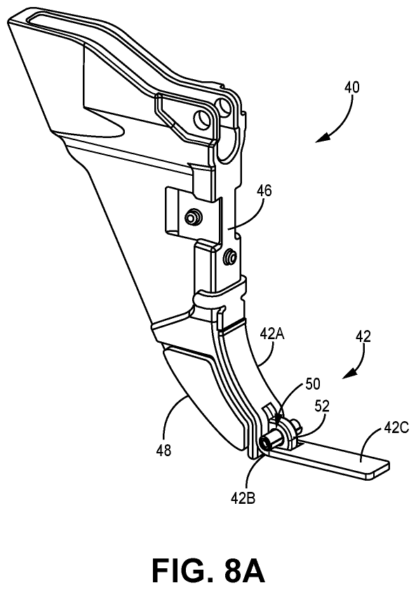

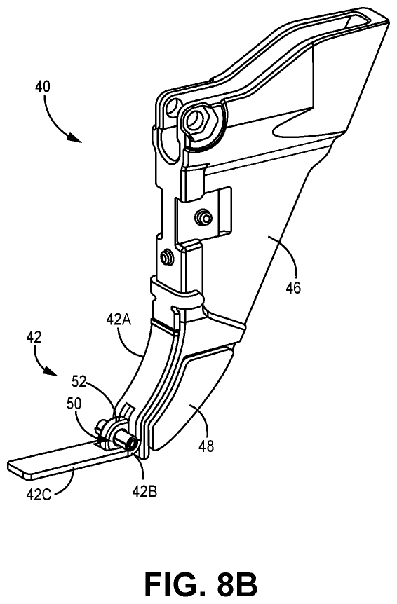

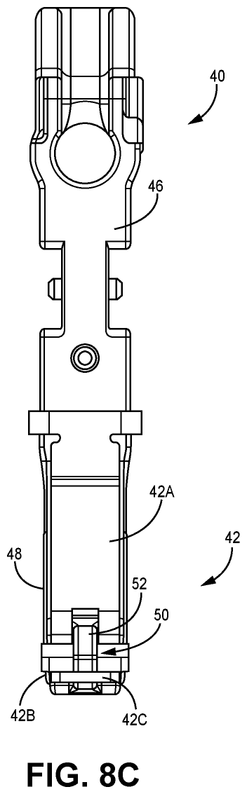

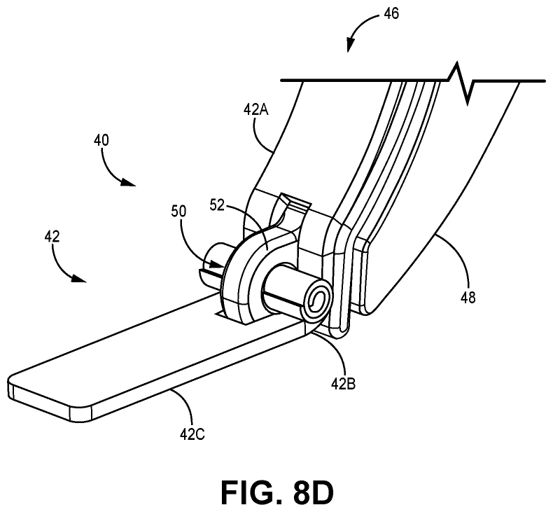

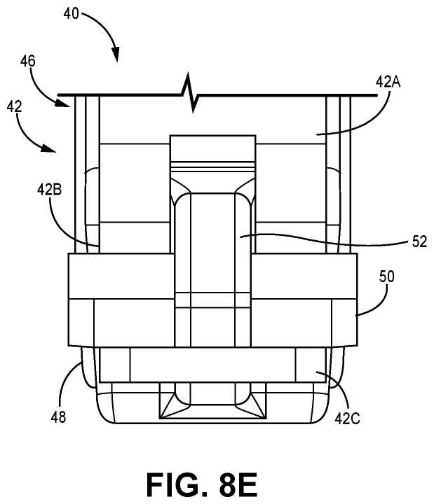

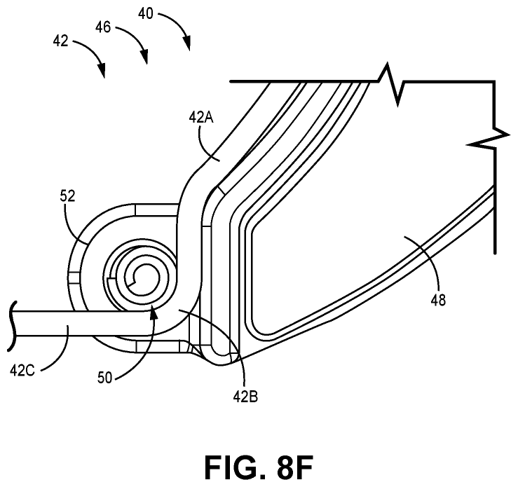

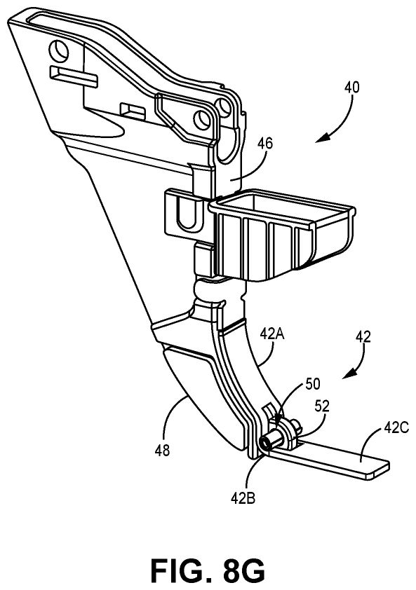

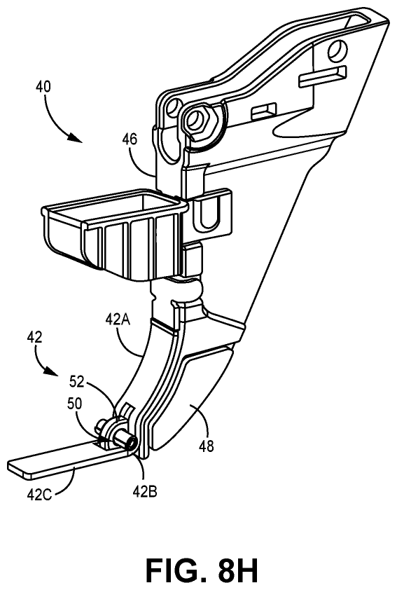

As shown in FIGS. 8A-H and 9A-B, in certain implementations, the body 46 includes optional common features such as carbide or other wear pads 48 to support the disc opener blades 14 that are located to either side on a planter row unit 12. In various implementations, the one or more wear pads 48 are located on a lower portion of the shield body 46 anterior to the spring plate 42, though alternate configurations are of course possible.

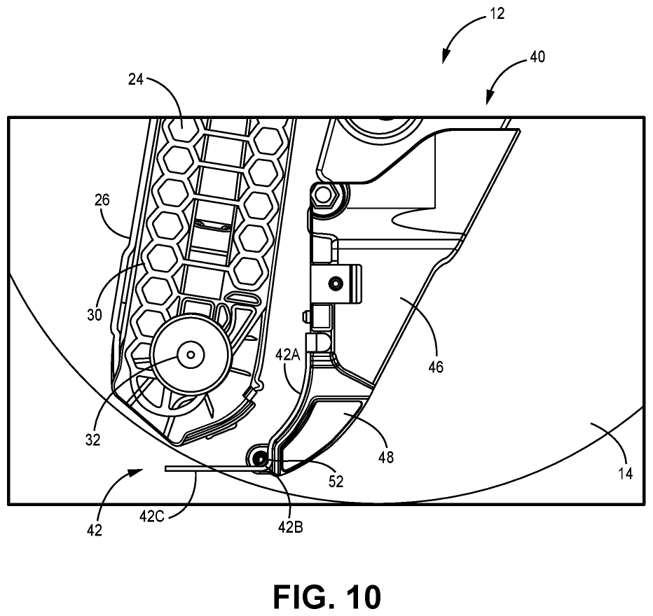

Continuing with FIGS. 8A-H and 9A-B, in various implementations, the extension 42C is a substantially flat portion of the spring plate 42 that projects rearward from the shield body 46 and below the seed delivery tube 26, shown for example in FIG. 10. In these implementations, the rearward projection/extension 42C of the spring plate 42 includes a spring pin 50.

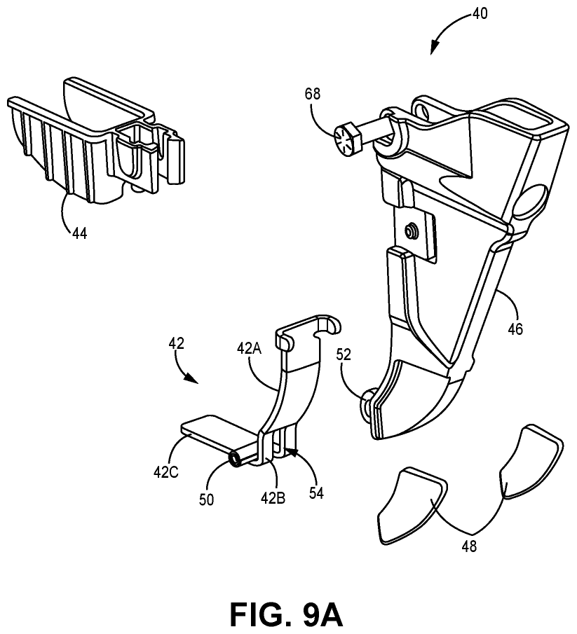

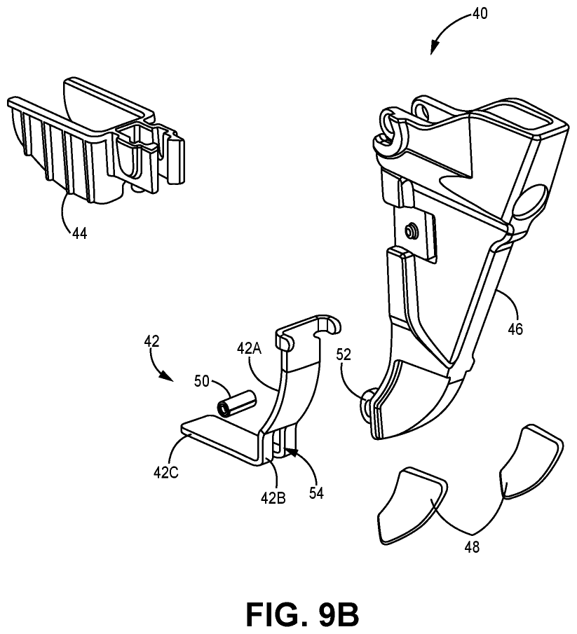

As shown generally in FIGS. 6A-10, in certain implementations, a formed radius 42B wraps at least partially around spring pin 50. In these implementations, any deflection of the spring plate 42 occurs at the junction of radius 42B and the outside dimeter of spring pin 50. The formed radius 42B wrapping around the spring pin 50 reduces the concentration of stresses due to deflection of the spring plate 42 as it passes over obstacles, debris, etc. Reducing the stress increases the service life of the row unit, shield 40, and spring pin 50.

In various implementations, a tang 52 is part of the structure of the body 46 of the seed delivery shield 40. The tang 52 locates and retains the spring pin 50 and the spring plate 42 by intersecting the spring plate 42 along an elongated aperture 54. In these implementations, the spring plate 42 is retained in all planes but is allowed to deflect vertically. Various alternative arrangements and mechanism for retaining the spring pin 50 are possible and would be appreciated by those of skill in the art.

The spring plate 42 acts such that any upward loading due to field impact or sitting on the soil surface when the planter row unit is lowered is at least partially absorbed by the spring pin 50 and spring plate 42. In these implementations, the impact/weight is not fully transferred to the mounting location of the seed tube guard 40 on the row unit.

Further, due to the length of the spring plate 42 extending beyond the seed exit point on the delivery tube 26, debris ingression into the delivery tube 26 is minimized, as would be readily appreciated. Alternate configurations are of course possible.

### Mounting

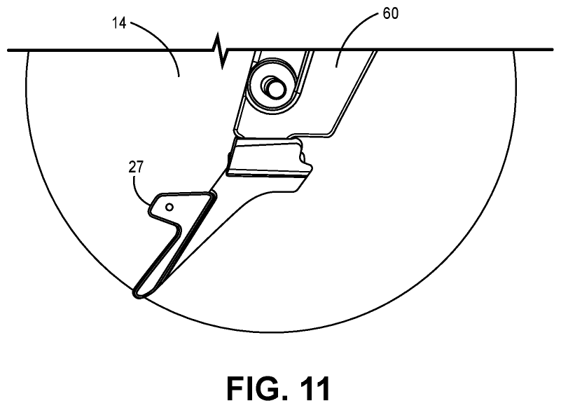

As would be appreciated by those of skill in the art, row crop planters that plant at high speeds or in hard field conditions, such as a no-till field, experience high stresses on the row unit shank 60, as seen for example in FIG. 11. These stresses are amplified by high-speed seed delivery systems that may drop the seed closer to the bottom of the furrow than traditional gravity seed delivery systems. Because of the lower delivery point for a high speed delivery system, the seed tube guard (such as those shown at 27 and 40 variously herein) must be lower to protect the seed delivery device.

As noted herein, the seed tube guard 27, 40 and its mounting locations must endure a lot of stress. Many known seed tube guard 27, 40 mounting features cannot handle the stress and will begin to crack and eventually break away completely from the row unit, as shown for example in FIG. 12 where arrow A points to a stress fracture/failure point along the shank 60 from compression stress (shown by arrow B) and tension stress (shown at arrow C). When this prior known mounting feature fails it can cause damage to the seed delivery system as well as cause a buildup of dirt and debris clogging the seed delivery system.

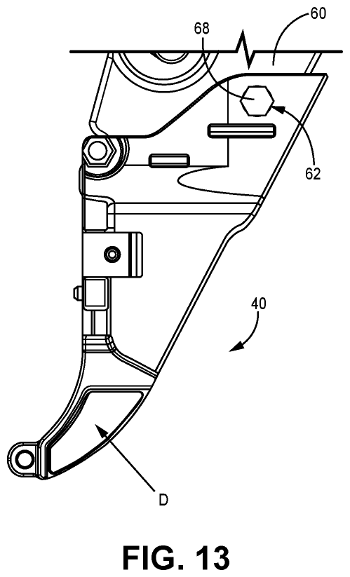

Additionally, it is known that dirt and debris can come between the seed tube guard 27, 40 and the shank 60 on the row unit. This can occur in many conditions, appreciated by those of skill in the art. When enough dirt packs between the guard 27, 40 and row unit shank 60 the dirt/debris can cause the guard 27, 40 to become off center in relation to the opening discs 14 and the seed delivery system. When the guard 27, 40 becomes off center it can cause premature wear against the opening discs 14, shown by arrow D in FIG. 13 where the opening discs 14 may rub again the guard 40, causing the user to change out opening discs 14 more frequently than expected.

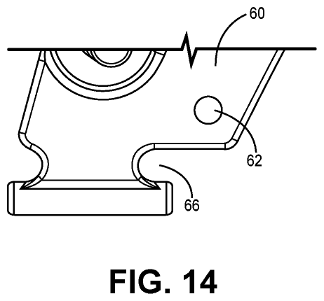

Described above is a seed tube guard 40, and now turning to a mounting feature that utilizes a roll pin 68 that is inserted through an opening 62 in a planter row unit shank 60, shown in FIG. 13. The purpose of this is to alleviate the stress around the OEM mounting feature (such as that shown in FIGS. 12 and 14). With stress alleviated, the row unit can operate in high speed and hard ground conditions without breaking the row unit shank 60 or causing other damage, such as that described above, to the row unit and its components.

As can be seen in FIG. 14 the opening 62 in the shank 60 experiences less stress than the OEM mounting feature 66. The OEM mounting feature 66 includes a thin section for mounting as well as a parting line along the shank 60 casting that can cause an increased concentration of stress, leading to breakage/cracking.

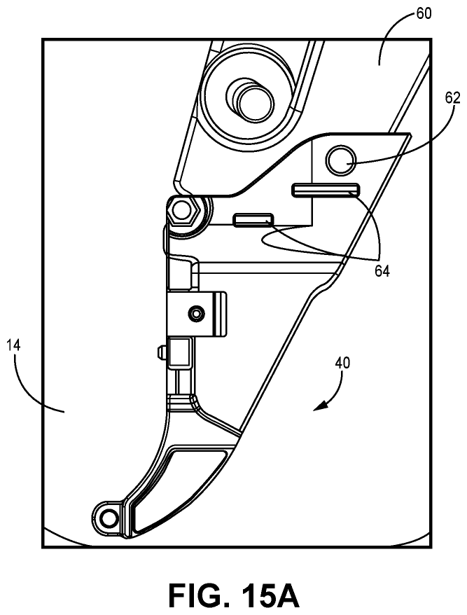

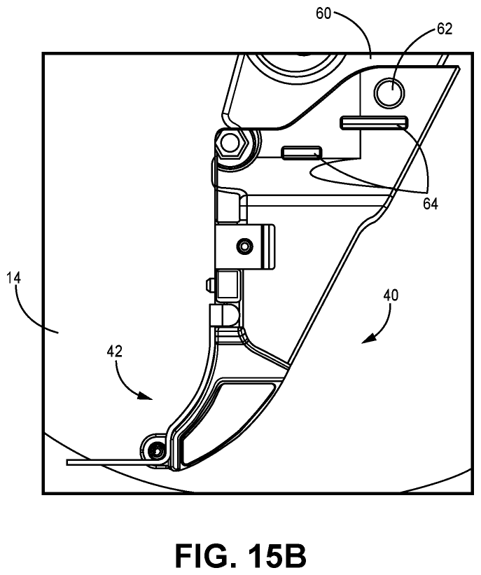

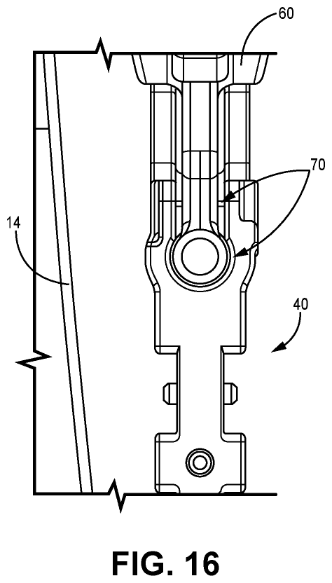

Turning to FIGS. 15A-B, in various implementations, the seed tube guard 40 includes one or more cutouts 64 to shed dirt that builds up between the seed tube guard 40 and the row unit shank 60. As noted above, and as shown in the volume gap 70 in FIG. 16, if too much dirt builds up between the guard 40 and the row unit shank 60 it can shift the seed tube guard 40 to become off center in relation to the delivery system and the opening discs 14 causing premature wear, discussed above.

The various implementations described herein prevent planter shanks 60 from failing due to high-speed planting or hard ground conditions. The various implementations, also allow shanks 60 that are broken/cracked already to still be used for high-speed planting, that is, broken shanks 60 can be retrofitted with an opening 62 for mounting a seed tube guard 40. Further, the various implementations allow guards 40 to self-center when experiencing debris ingression, such as by shedding debris/dirt through openings 64 and/or via a side retention device 44, described above.

In various implementations, a seed tube guard 27, 40 is mounted via a roll pin 68 inserted through corresponding openings in proximal end of the seed tube guard 27, 40 and a lower portion of the body of the shank 60 of the row unit. By moving the stress point to this more robust and stable portion of the shank 60, stress is moved away from the failure point (see A in FIG. 12) on the row unit shank 60 to the point where the roll pin 68 makes contact with the shank 60. This area experiences significantly less stress compared to the OEM mounting feature 66 for the row unit.

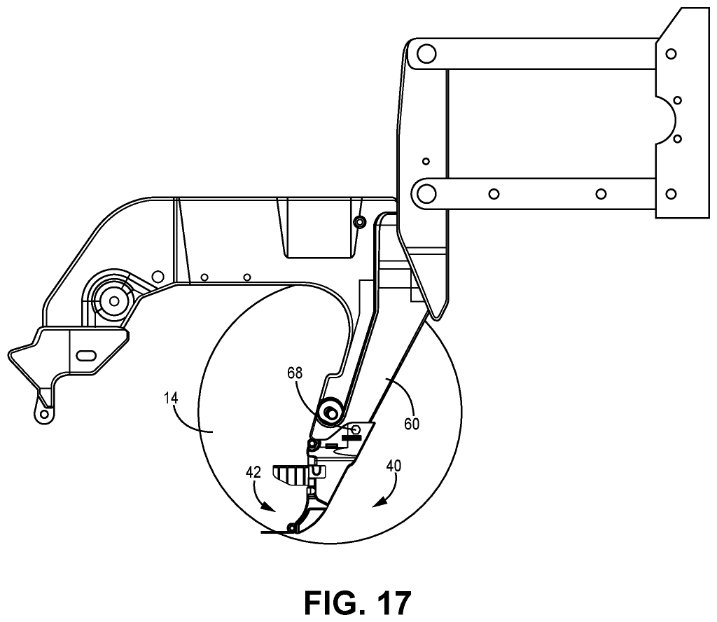

Additionally, the mounting feature described herein also allows dirt that normally gets trapped between the seed tube guard 27, 40 and the shank 60 out of the relief points 64 in the seed tube guard 27, 40. This allows the guard 27, 40 to self-center in relation to the opening discs 14 creating a more even and symmetrical wear pattern between both opening discs 14. FIG. 17 shows the seed tube guard 40 mounted to the row unit shank 60 via the roll pin 68 feature. FIG. 17 further shows the guard 40 in relation to an opening disc 14.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. patent application Ser. No. 16/997,040, filed Aug. 19, 2020, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. patent application Ser. No. 17/225,740, filed Apr. 8, 2021, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,678, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. Patent Application 63/357,284, filed Jun. 30, 2022, entitled “Grain Cart Bin Level Sharing,” U.S. Patent Application 63/394,843, filed Aug. 3, 2022, entitled “Hydraulic Cylinder Position Control for Lifting and Lowering Towed Implements,” U.S. Patent Application 63/395,061, filed Aug. 4, 2022, entitled “Seed Placement in Furrow,” U.S. Patent Application 63/400,943, filed Aug. 25, 2022, entitled “Combine Yield Monitor,” U.S. Patent Application 63/406,151, filed Sep. 13, 2022, entitled “Hopper Lid with Magnet Retention and Related Systems and Methods,” U.S. Patent Application 63/427,028, filed Nov. 21, 2022, entitled “Stalk Sensors and Associated Devices, Systems and Methods,” U.S. Patent Application 63/445,960, filed Feb. 15, 2023, entitled “Ear Shelling Detection and Related Devices, Systems, and Methods,” U.S. Patent Application 63/445,550, filed Feb. 14, 2023, entitled “Liquid Flow Meter and Flow Balancer,” U.S. Patent Application 63/466,144, filed May 12, 2023, entitled “Devices, Systems, and Methods for Providing Yield Maps,” and U.S. Patent Application 63/466,560, filed May 15, 2023, entitled “Devices, Systems, and Methods for Agricultural Guidance and Navigation,” each of which is incorporated herein by reference.

Although the disclosure has been described with references to various embodiments, persons skilled in the art will recognized that changes may be made in form and detail without departing from the spirit and scope of this disclosure.

What is claimed is:

1. A seed delivery system shield, comprising:
(a) a shield body;
(b) a side retention apparatus configured to maintain alignment of the shield body to a seed tube; and
(c) a spring plate shaped to be at least partially engaged with a rear portion of the shield body and extending rearward beneath the seed tube.

2. The shield of claim 1, further comprising an opening disposed at a proximal end of the shield body configured for insertion of a roll pin for mounting the shield body to a row unit shank.

3. The shield of claim 1, wherein the spring plate further comprises:
(a) a first portion shaped to be fitted with a side of the shield body;
(b) a second portion forming a radius connecting the first portion and a third portion; and
(c) the third portion extending from the second portion opposite the shield body.

4. The shield of claim 3, wherein the first portion of the spring plate is configured to act as a lever against forced exerted on the third portion of the spring plate.

5. The shield of claim 3, wherein the third portion of the spring plate is substantially flat.

6. The shield of claim 3, wherein the second portion of the spring plate is wrapped at least partially around a spring pin.

7. The shield of claim 3, wherein the spring plate further comprises an elongated aperture centrally located along the second portion.

8. The shield of claim 1, wherein the shield body further comprises a tang configured to retain a spring pin.

9. The shield of claim 1, further comprising at least one debris relief opening at the proximal end of the shield body.

10. The shield of claim 1, further comprising one or more wear pads on the shield body.

11. The shield of claim 10, wherein the one or more wear pads are carbide.

12. A shield for protecting a seed delivery system, comprising:
(a) a shield body;
(b) a spring plate, comprising:
(i) a first portion shaped to be engaged with a rear portion of the shield body;
(ii) a second portion extending rearwardly from the first portion to below a seed tube of the seed delivery system; and
(iii) a third portion connecting the first portion and the second portion of the spring plate,
(c) a spring pin configured to hold the spring plate to the shield body,
wherein deflection of the spring plate occurs at the second portion of the spring plate and the spring pin.

13. The shield of claim 12, wherein the spring plate deflects vertically.

14. The shield of claim 12, wherein the spring plate prevents field residue from being picked up by the seed delivery system.

15. The shield of claim 12, further comprising a side retention device extending from the shield body and configured to maintain alignment of the shield and the seed tube.

16. The shield of claim 12, wherein the second portion is substantially flat.

17. The shield of claim 12, wherein the shield body comprises a tang extending through an elongate aperture in the third portion to retain the spring pin.

18. The shield of claim 12, further comprising at least one debris relief opening and wherein the heild body is configured to be mounted to a row unit shank via a roll pin.

19. The shield of claim 12, further comprising one or more wear pads on the shield body.

20. A seed tube shield for use on an agricultural row unit, comprising:
(a) a shield body, comprising;
(i) at least one roll pin opening configured for mounting the shield body to a row unit shank via a roll pin; and
(ii) at least one debris relief opening;
(b) a spring plate, comprising:
(i) a first portion shaped to be engaged with a rear portion of the shield body;
(ii) a second portion extending rearwardly from the first portion; and
(iii) a third portion connecting the first portion and the second portion of the spring plate;
(c) a tang extending from the shield body configured to retain a spring pin and extend through an elongate aperture in the third portion;
(d) at least two wear pads, disposed on opposing sides of the shield body; and
(e) a retention device extending rearwardly from the shield body configured to maintain alignment of a seed tube.
